(19) United States
(12) Patent Application Publication
(10) Pub. No.: US 2008/0043593 A1
(43) Pub. Date: Feb. 21, 2008

(54) ADAPTIVELY LEARNING METHOD AND APPARATUS FOR IMPROVING A WRITE STRATEGY

(75) Inventors: Ling-Feng Chen, Hsinchu (TW); Chien-Li Hung, Hsinchu (TW)

Correspondence Address: KIRTON AND MCCONKIE, 60 EAST SOUTH TEMPLE,, SUITE 1800, SALT LAKE CITY, UT, 84111, US

(73) Assignee: LITE-ON IT CORP., Taipei City (TW)

(21) Appl. No.: 11/464,569

(22) Filed: Aug. 15, 2006

(51) Int. Cl. G11B 7/0045

(52) U.S. Cl. 369/59.11

(57) ABSTRACT

An adaptively learning method and apparatus is used for improving a write strategy for discs of the same type produced by the same manufacturer. When a write action is completed, the previous written data is reproduced for checking the write quality of the written data. If the write quality does not comply with requirements, the write strategy will be tuned and the new write strategy will be recorded into a memory for the use of next write action. In this way, the write quality of the present write action will be better than that of the previous write action so as to maintain the write quality.

### FIELD OF THE INVENTION

The present invention relates to an adaptively learning method and apparatus for improving a write strategy, and more particularly to an adaptively learning method and apparatus for improving a write strategy of optical discs of the same type produced by the same manufacturer.

### BACKGROUND OF THE INVENTION

In general, in response to a write command issued by a host, all associated data will be immediately written into an optical disc by an optical disc drive so as to complete a write action. During the procedure of the write action, the data will be encoded by a control chip of the optical disc drive. For example, data in a CD will be encoded into 8/14 modulation signals (Eight to Fourteen Modulation) by a control chip; and data in a DVD will be encoded into 8/16 modulation signals (Eight to Sixteen Modulation) by a control chip. The 8/14 or 8/16 modulation signals represent the Lands and Pits information formed on tracks of an optical disc, and the resulting recording length of Lands and Pits must lie between 3 T to 11 T.

During the write action, one kind of structure so called as “Pit” may be formed on the track of the optical disc when a relatively high laser power emitted by the optical disc drive is focused on the track, and another kinds of structure so called as “Land” may be formed on the track of the optical disc when a relatively low laser power emitted by the optical disc drive is focused on the track. Moreover, a write strategy is referred by the optical disc drive to define a driving signal of a laser diode for selectively forming the Land and Pit structures on an optical disc. The write strategy is generally defined in the specification of an optical disc drive.

FIG. 1a illustrates an example of a write strategy for writing a CD-R, and FIG. 1b illustrates an example of another write strategy for writing a CD-RW. Because different types of optical discs have different dye material functioning as the data layer, different write strategies will be suitable for different types of optical discs to form a similar structure including Land 15, Pit 10 and Pit 20. For example, according to the write strategy of a CD-R, a Pit structure can be form on the CD-R by a laser diode which is driven by a pulse having an amplitude of PW (Write Power). On the contrary, according to the write strategy of a CD-RW, a Pit structure can be form on the CD-RW by a laser diode which is driven by a plurality of pulses having amplitudes of PW or PB (Bias Power). Furthermore, according to the write strategy of a CD-RW, a Land structure can be form on the CD-RW by a laser diode which is driven by a pulse having an amplitude of PE (Erase Power).

Even for the optical discs of the same type, the dye material could vary with the disc manufacturers. Accordingly, write strategies may differ. Therefore, before a new optical disc drive can be commercialized, a series of tests for optical discs of different types produced by different manufacturers must be preformed, and write strategies for these tested optical discs are recorded into a memory of the optical disc drive.

For example, a write strategy suggested by a certain specification of CD-R will be provided as a standard write strategy of CD-R. For CD-R produced by other manufacturers, the write strategy needs to be modified by adjusting one or more parameters of the standard write strategy, e.g. power, pulse start, pulse end and/or pulse width. In this way, write strategies for CD-R produced by different manufacturers can be located according to the recorded standard write strategy of CD-R. Similar modification can be applied to other types of optical discs such as DVD+R, DVD+RW, DVD-R, DVD-RW, CD-R and CD-RW.

When an optical disc is loaded into an optical disc drive, the type of the loaded optical disc will be first determined by the optical disc drive, and then the manufacturer of the loaded optical disc will be determined by referring to a data track of the loaded optical disc. After the type and the manufacturer of the loaded optical disc are determined, a specific write strategy for the loaded optical disc will be read from the memory by the control chip of the optical disc drive, and then predetermined Land and Pit structures can be formed on the tracks of the optical disc according to the specific write strategy.

Unfortunately, it is impossible to record the write strategies of all optical discs of different types produced by different manufacturers in the memory of the optical disc drive due to the limited memory capacity. In general, only the write strategies of optical discs produced by some large and famous manufacturers will be recorded in the memory. For those write strategies of optical discs not recorded in the memory, a standard write strategy will be applied. Therefore, when an optical disc is loaded in an optical disc drive, the type of the loaded optical disc will be first determined by the optical disc drive, and then the manufacturer of the loaded optical disc will be determined by referring to a data track of the loaded optical disc. If there is no specific write strategy for the loaded optical disc in the memory, a standard write strategy recorded in the memory will be used to write the loaded optical disc by the optical disc drive. For example, a standard DVD+R write strategy will be used to write the loaded DVD+R optical disc which has no corresponding write strategy recorded in the memory. Although a write action is able be completed according to the standard write strategy, the resulting writing quality would be unsatisfactory. For example, there might be a high access-failure rate, which means the data written in the optical disc could be unable to be successfully accessed by the optical disc drive.

A suitable write strategy is important when the user tends to use optical discs of a certain brand. He may have bought tens or hundreds of discs at a time. If the write strategy for that kind of optical disc is not recorded in the memory of the optical disc drive, and a standard write strategy is always used for the write actions of all tens or hundreds of discs, the user might suffer from poor writing quality of all these discs.

FIG. 2 depicts a flowchart of a method for improving the writing quality according to prior art. In U.S. Pat. No. 6,636,468, an OPC (Optimum Power Control) calibration is executed by the optical disc drive (step 415) to set a laser power (step 420), and then data starts to be written into an optical disc with the laser power (this time point is recorded as a starting point) (step 425).

During data is written into the optical disc (step 427), if a trigger has sent a signal to reevaluate the laser power (this time point is recorded as a stopping point) (step 430), the optical disc drive stops writing and then the written data is read and checked by the optical disc drive (step 440). If the writing quality of the written data does not comply with requirement, the laser power of the optical disc drive need to be tuned and a new laser power is determined according to the writing quality of the written data (step 445 and step 455). On the contrary, if the writing quality of the written data is satisfactory, the laser power need not be tuned (step 445). Afterwards, the optical disc drive will find the starting point (step 450), and data will be rewritten into the optical disc with the original or tuned laser power (step 425).

According to the above-described prior art, the optical disc drive reevaluates the laser power during the write action is being executed. Therefore, no matter if the writing quality of the written data is satisfactory, another write action needs to be executed from the starting point, i.e. the optical head has to be moved back to a previous track. The procedure will delay the write action. In addition, complicated control is involved to make sure the written data is continuous. Moreover, as the improvement of the writing condition is performed during the write action, complicated circuitry is required to determine whether the reevaluation of the laser power is required or not. Otherwise, the entire laser-power adjusting procedure has to be executed one more time when another optical disc, which could be the same type and produced by the same manufacturer as the previous disc, is loaded.

### SUMMARY OF THE INVENTION

Therefore, the present invention provides an adaptively learning method for improving a write strategy, and the improved write strategy can be directly used for next loaded optical disc of the same type produced by the same manufacturer.

According to an embodiment of the present invention, an adaptively learning method for use in an optical disc drive to write an optical disc of a specific type produced by a specific manufacturer comprises steps of: executing a write action to obtain a written data according to a first write strategy recorded in a memory; detecting a writing quality of the written data after the write action is completed; determining whether the first write strategy needs to be tuned or not according to the write quality of the written data; and tuning the first write strategy to result in a second write strategy and recording the second write strategy into the memory when the write quality of the written data does not comply with a preset criterion.

In an embodiment, the second write strategy replaces the first write strategy to be recorded in the memory and used for executing next write action of an optical disc of the specific type produced by the specific manufacturer.

In an embodiment, the adaptively learning method further includes steps of: executing another write action to obtain another written data according to the second write strategy recorded in the memory; detecting a writing quality of the another written data after the write action according to the second write strategy is completed; determining whether the second write strategy needs to be tuned or not according to the write quality of the another written data; and tuning the second write strategy to result in a third write strategy and recording the third write strategy into the memory to replace the second write strategy when the write quality of the written data does not comply with the preset criterion.

For example, the write action can be a TAO (Track At Once) write action, a SAO (Session At Once) write action, a DAO (Disc At Once) write action, or a write action of a Package Write.

For example, the first write strategy can be tuned by adjusting parameters of a laser power, the starting point of a pulse, the ending point of a pulse or the width of a pulse. The laser power may include a Write Power, an Erase Power and/or a Bias Power.

In an embodiment, the memory is a non-volatile memory.

For example, the preset criterion can be a predetermined access-failure rate.

In an embodiment, the first write strategy is a preset write strategy recorded in the memory for writing an unidentified optical disc. Alternatively, the first write strategy is a preset write strategy recorded in the memory for writing an optical disc of the specific type produced by the specific manufacturer.

### BRIEF DESCRIPTION OF THE DRAWINGS

The above contents of the present invention will become more readily apparent to those ordinarily skilled in the art after reviewing the following detailed description and accompanying drawings, in which:

FIG. 1a is a schematic diagram illustrating an example of a write strategy of CD-R.

FIG. 1b is a schematic diagram illustrating another example of a write strategy of CD-RW.

FIG. 2 is a flowchart of a method for improving the write quality according to prior art.

FIG. 3 is a flowchart of an adaptively learning method for improving a write strategy according to the present invention.

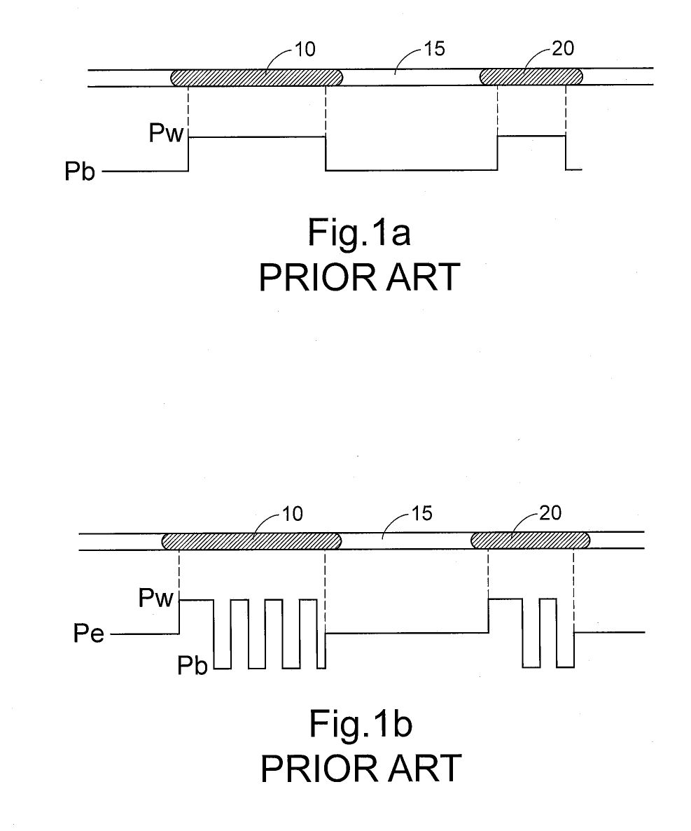

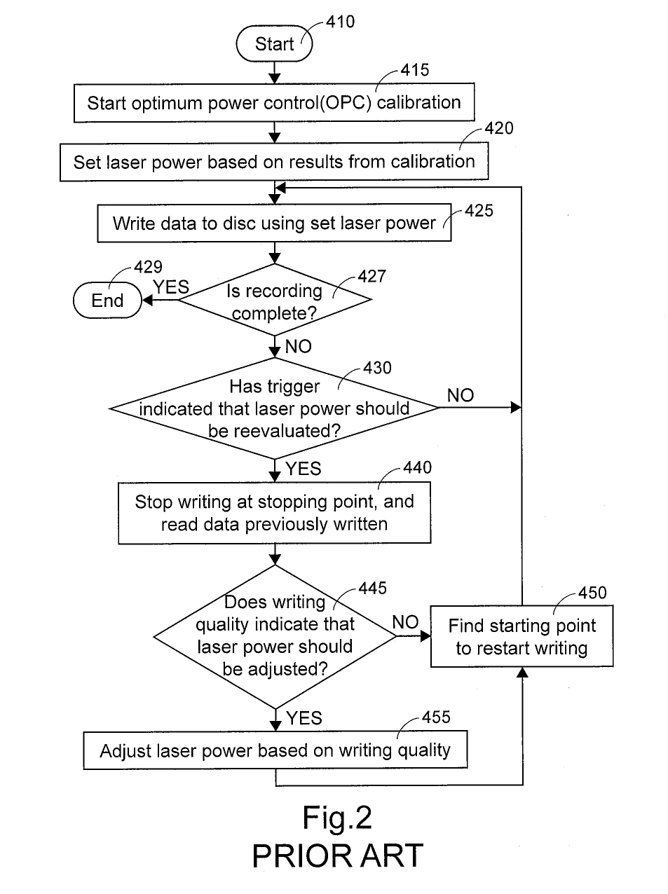

### DETAILED DESCRIPTION OF THE PREFERRED EMBODIMENT

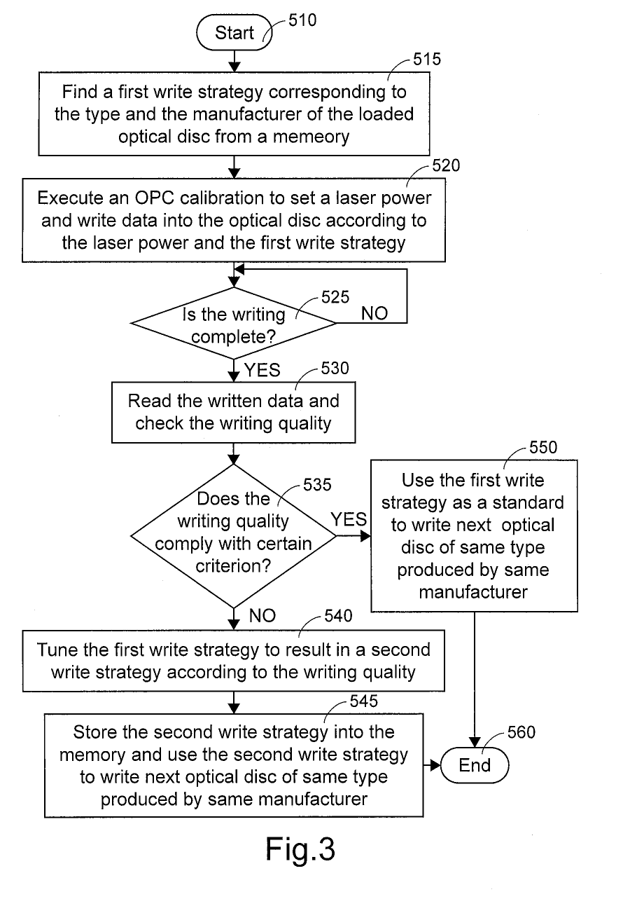

FIG. 3 depicts a flowchart of an adaptively learning method for improving a write strategy according to the present invention. When an optical disc is loaded in an optical disc drive to be written therein data (step 510), the type and the manufacturer of the loaded optical disc are first determined by the optical disc drive, and then a first write strategy for the loaded optical disc is located from the memory to be executed by the optical disc drive (step 515). Then, an OPC calibration is executed by the optical disc drive for setting a laser power, and data is written into the optical disc with the laser power according to the first write strategy (step 520). After the data is completely written into the optical disc (step 525), the previous written data is read out and the writing quality is checked by the optical disc drive (step 530). Then, whether the write strategy needs to be tuned or not can be determined by the optical disc drive according to the writing quality of the written data (step 535). If the writing quality is determined to be fine, there is no need to tune the write strategy, and thus the first write strategy can be used as a standard for writing this type of optical discs produced by the same manufacturer (step 550). On the contrary, if the writing quality is determined unsatisfactory, e.g. it does not comply with a certain criterion, the write strategy needs to be tuned according to the writing quality (step 540). The tuned write strategy is recorded into the memory to replace the first write strategy (step 545) and used as a standard for writing this type of optical discs produced by the same manufacture.

In Step 540 where the write strategy is tuned according to the writing quality of previously written data, a plurality of writing parameters can be adjusted in addition to laser power. For example, if the read Pit or Land length, e.g. 4.2 T, is greater than the required length, e.g. 4 T, it means the pulse width recorded in the write strategy need be decreased. Furthermore, there might be other parameters recorded in the write strategy to be checked and adjusted when necessary, for example the starting and ending points of the pulse.

Moreover, the write action defined in the present invention can be a TAO (Track At Once) write action, a SAO (Session At Once) write action, a DAO (Disc At Once) write action, or a write action of a Package Write.

In an embodiment, the first write strategy can be a preset write strategy for writing those unidentified optical discs. After an improved write strategy is obtained according to the present adaptively learning method and recorded in the memory of the optical disc drive, next loaded optical disc of the same type produced by the same manufacturer can be written under better writing conditions. Therefore, the writing quality can be improved without delaying the write action as the above-mentioned prior art does. Alternatively, the first write strategy can be a write strategy that has already been recorded in the memory for writing an identifiable disc. The write strategy can be improved by replacing the existing write strategy with a tuned write strategy according to the present adaptively learning method. Of course, the write strategy can be further improved by replacing the second write strategy with a third write strategy obtained by repeating the present adaptively learning method for another optical disc.

To sum up, the present invention provides an adaptively learning method for improving a write strategy, and the improved write strategy can be directly used for next loaded optical disc of the same type produced by the same manufacturer without stopping and restarting the write action.

The adaptively learning method of the present invention can be implemented with a control chip. The control chip reads the first write strategy from the memory, records new write strategy to the memory, and controls the optical head according to original or new write strategy.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims, which are to be accorded with the broadest interpretation so as to encompass all such modifications and similar structures.

What is claimed is:

1. An adaptively learning method for use in an optical disc drive to write an optical disc of a specific type produced by a specific manufacturer, comprising steps of:
executing a write action to obtain a written data according to a first write strategy recorded in a memory;
detecting a writing quality of the written data after the write action is completed;
determining whether the first write strategy needs to be tuned or not according to the write quality of the written data; and
tuning the first write strategy to result in a second write strategy and recording the second write strategy into the memory when the write quality of the written data does not comply with a preset criterion.

2. The method according to claim 1 wherein the second write strategy replaces the first write strategy to be recorded in the memory and used for executing next write action of an optical disc of the specific type produced by the specific manufacturer.

3. The method according to claim 1 further comprising steps of:
executing another write action to obtain another written data according to the second write strategy recorded in the memory;
detecting a writing quality of the another written data after the write action according to the second write strategy is completed;
determining whether the second write strategy needs to be tuned or not according to the write quality of the another written data; and
tuning the second write strategy to result in a third write strategy and recording the third write strategy into the memory to replace the second write strategy when the write quality of the written data does not comply with the preset criterion.

4. The method according to claim 1 wherein the write action is a TAO (Track At Once) write action, a SAO (Session At Once) write action, a DAO (Disc At Once) write action, or a write action of a Package Write.

5. The method according to claim 1 wherein the first write strategy is tuned by adjusting parameters of a laser power, the starting point of a pulse, the ending point of a pulse or the width of a pulse.

6. The method according to claim 5 wherein the laser power includes a Write Power, an Erase Power and/or a Bias Power.

7. The method according to claim 1 wherein the memory is a non-volatile memory.

8. The method according to claim 1 wherein the preset criterion is a predetermined access-failure rate.

9. The method according to claim 1 wherein the first write strategy is a preset write strategy recorded in the memory for writing an unidentified optical disc.

10. The method according to claim 1 wherein the first write strategy is a preset write strategy recorded in the memory for writing an optical disc of the specific type produced by the specific manufacturer.
